(19) United States
(12) Patent Application Publication
(10) Pub. No.: US 2006/0098596 A1
(43) Pub. Date: May 11, 2006

(54) Providing digital broadcasting data using wireless local area network (WLAN)

(76) Inventors: Jong-Ho Park, Yongin-si (KR); Young-Jip Kim, Suwon-si (KR); Seung-Mi Kang, Yongin-si (KR); Jong-Chang Lee, Suwon-si (KR); Young-Seop Han, Suwon-si (KR)

Correspondence Address: Robert E. Bushnell, Suite 300, 1522 K Street, N.W., Washington, DC, 20005, US

(21) Appl. No.: 11/262,916

(22) Filed: Nov. 1, 2005

(30) Foreign Application Priority Data
Nov. 5, 2004 (KR) 2004-0090023

(51) Int. Cl. H04Q 7/00; H04J 3/18

(52) U.S. Cl. 370/329; 370/477

(57) ABSTRACT

An apparatus to provide digital broadcasting data using a Wireless Local Area Network (WLAN) includes: a digital broadcasting processor adapted to receive, demodulate, decode, and output multi-channel digital broadcasting data; a transcoder adapted to receive the demodulated digital broadcasting data from the digital broadcasting processor, to convert the digital broadcasting data into a format transmittable over a Wireless Local Area Network (WLAN), and to output the converted digital broadcasting data; and a WLAN processor adapted to transmit the converted digital broadcasting data to a wireless terminal device connected to the WLAN. The method includes: establishing a session using a Wireless Local Area Network (WLAN) between the multi-channel broadcasting receiver and a wireless terminal device, the wireless terminal device being connected to the multi-channel broadcasting receiver via the WLAN, in response to a wireless terminal device's request; converting the digital broadcasting data received by the multi-channel broadcasting receiver into a format transmittable via the WLAN in response to a digital broadcasting service request from the wireless terminal device; and transmitting the converted digital broadcasting data to the wireless terminal device via the WLAN.

### CLAIM OF PRIORITY

This application makes reference to, incorporates the same herein, and claims all benefits accruing under 35 U.S.C. § 119 from an application for APPARATUS FOR PROVIDING DIGITAL BROADCASTING DATA USING WIRELESS LOCAL AREA NETWORK AND METHOD THE SAME earlier filed in the Korean Intellectual Property Office on Nov. 5, 2004 and there duly assigned Serial No. 2004-0090023.

### BACKGROUND OF THE INVENTION

1. Field of the Invention

The present invention relates to receiving digital broadcasting data and, more particularly, to receiving digital broadcasting data using a Wireless Local Area Network (WLAN).

2. Description of the Related Art

With the beginning of a digital broadcasting service, the number of digital and analog broadcasting channels transmitted over terrestrial, cable, satellite, and/or the like is increasing and amounts to 100 or more channels. In order to receive broadcasting signals of such channels, a Set Top Box (STB) is required.

Typically, the STB is utilized in conjunction with a television receiver (hereinafter referred to as a ‘TV’). The STB receives various multi-channel TV image data and Electronic Program Guide (EPG) data transmitted over a network and/or a satellite and provides them to users.

Conventionally, such an STB must be connected and used with the TV. That is, it was only possible to view the multi-channel broadcasting data received through the STB on the TV.

Since wireless terminals with display and speaker functions (e.g., cellular phones, and Personal Digital Assistants (PDAs) have been popularized by virtue of the recent communication technology developments, a need has arisen to connect the wireless terminal and the STB using a WLAN and to receive digital broadcasting data using the connected wireless terminal.

However, conventionally, there has been no interface between the STB and the wireless terminal for transmitting the digital broadcasting data and EPG data. Accordingly, it is impossible for the wireless terminal to receive the digital broadcasting data from the STB, because a bandwidth of the digital broadcasting data processed by the STB is different from that of data that can be received by the wireless terminal.

### SUMMARY OF THE INVENTION

An object of the present invention to provide an apparatus and method to provide digital broadcasting data using a WLAN.

According to an aspect of the present invention, an apparatus is provided comprising: a digital broadcasting processor adapted to receive, demodulate, decode, and output multi-channel digital broadcasting data; a transcoder adapted to receive the demodulated digital broadcasting data from the digital broadcasting processor, to convert the digital broadcasting data into a format transmittable over a Wireless Local Area Network (WLAN), and to output the converted digital broadcasting data; and a WLAN processor adapted to transmit the converted digital broadcasting data to a wireless terminal device connected to the WLAN.

According to another aspect of the present invention, a wireless terminal device is provided comprising: a Wireless Local Area Network (WLAN) processor adapted to, in response to a user's request, connect to a multi-channel broadcasting receiver that receives multi-channel digital broadcasting data via a WLAN, request the digital broadcasting data from the multi-channel broadcasting receiver, and receive the digital broadcasting data from the multi-channel broadcasting receiver; and a digital broadcasting processor adapted to demodulate, decode and output the digital broadcasting data received by the WLAN processor.

According to yet another aspect of the present invention, a method is provided comprising: establishing a session using a Wireless Local Area Network (WLAN) between a multi-channel broadcasting receiver and a wireless terminal device, the wireless terminal device being connected to the multi-channel broadcasting receiver via the WLAN, in response to a wireless terminal device's request; converting digital broadcasting data received by the multi-channel broadcasting receiver into a format transmittable via the WLAN in response to a digital broadcasting service request from the wireless terminal device; and transmitting the converted digital broadcasting data to the wireless terminal device via the WLAN.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of an apparatus to provide digital broadcasting data according to an embodiment of the present invention;

FIG. 2 is a block diagram of a multi-channel broadcasting receiver according to an embodiment of the present invention;

FIG. 3 is a block diagram of a Personal Digital Assistant (PDA) according to an embodiment of the present invention;

FIG. 4 is a process sequence diagram of a process to provide digital broadcasting data according to an embodiment of the present invention;

FIG. 5 is a flowchart of a process in which a multi-channel broadcasting receiver according to an embodiment of the present invention provides a corresponding service in response to a Personal Digital Assistant's (PDA's) broadcasting data request;

FIG. 6 is a flowchart of a process in which a multi-channel broadcasting receiver according to an embodiment of the present invention provides a corresponding service in response to a Personal Digital Assistant's (PDA's) state information request;

FIG. 7 is a flowchart of a process in which a multi-channel broadcasting receiver according to an embodiment of the present invention provides a corresponding service in response to a Personal Digital Assistant's (PDA's) EPG request; and

FIG. 8 is a flowchart of a process in which a multi-channel broadcasting receiver according to an embodiment of the present invention provides a corresponding service in response to a Personal Digital Assistant's (PDA's) session termination request.

### DETAILED DESCRIPTION OF THE INVENTION

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and fully convey the scope of the present invention to those skilled in the art. Like numbers refers to like elements throughout the specification.

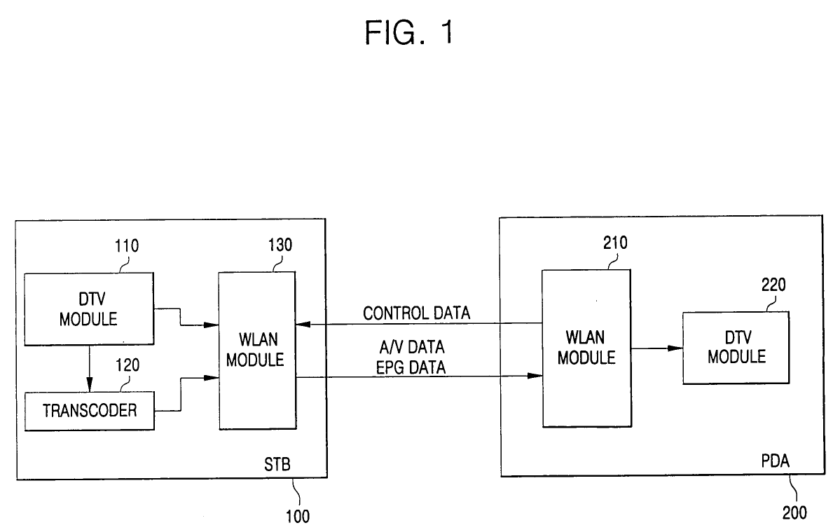

FIG. 1 is a block diagram of an apparatus to provide digital broadcasting data according to an embodiment of the present invention. Referring to FIG. 1, the apparatus to provide digital broadcasting data according to an embodiment of the present invention includes a Set Top Box (STB) 100 to transmit digital broadcasting data to a wireless terminal device (e.g., a PDA in FIG. 1) 200 over a WLAN, and the wireless terminal device 200 to receive the digital broadcasting data from the STB 100 and to output the received digital broadcasting data.

The STB 100 includes a Digital TV (DTV) module 110, a transcoder 120, and a WLAN module 130.

The DTV module 110 functions as a traditional digital broadcasting data processor. For example, the DTV module 110 operates to receive various multi-channel TV image data and Electronic Program Guide (hereinafter, referred to as ‘EPG’) data over a network or satellite and to output the data to the TV.

The transcoder 120 converts the digital broadcasting data, which is transmitted from the DTV module 10, to a format transmittable over the WLAN. For example, the transcoder 120 compresses digital broadcasting data at 19.4 Mbps from the DTV module 110. When transmitting the digital broadcasting data over an 802.11b network, the transcoder 120 reduces the bandwidth of the digital broadcasting data to be less than 11 Mbps because the 802.11b network has a bandwidth of transmittable data of 11 Mbps.

The WLAN module 130 transmits the digital broadcasting data to the PDA 200 over the WLAN in response to control data from the PDA 200. For example, the WLAN module 130 transmits the digital broadcasting data (e.g., Audio/Video data, hereinafter referred to as ‘A/V data’), converted by the transcoder 120, to the PDA 200 via the WLAN in response to a broadcasting request instruction from the PDA 200, and transmits EPG data to the PDA 200 via the WLAN in response to a program information request instruction from the PDA 200.

The PDA 200 includes a WLAN module 210 and a DTV module 220.

The WLAN module 210 is connected to the WLAN module 130 of the STB 100 over the WLAN to convey control data (e.g., a service request instruction) to the WLAN module 130 of the STB 100 and to receive the digital broadcasting data (e.g., the A/V data) from the WLAN module 130 of the STB 100 and to transmit the received digital broadcasting data to the DTV module 220.

The DTV module 220 performs traditional digital broadcasting data processing. That is, the DTV module 220 performs processing to display the digital broadcasting data and/or the EPG data received via the WLAN module 210 on the PDA 200.

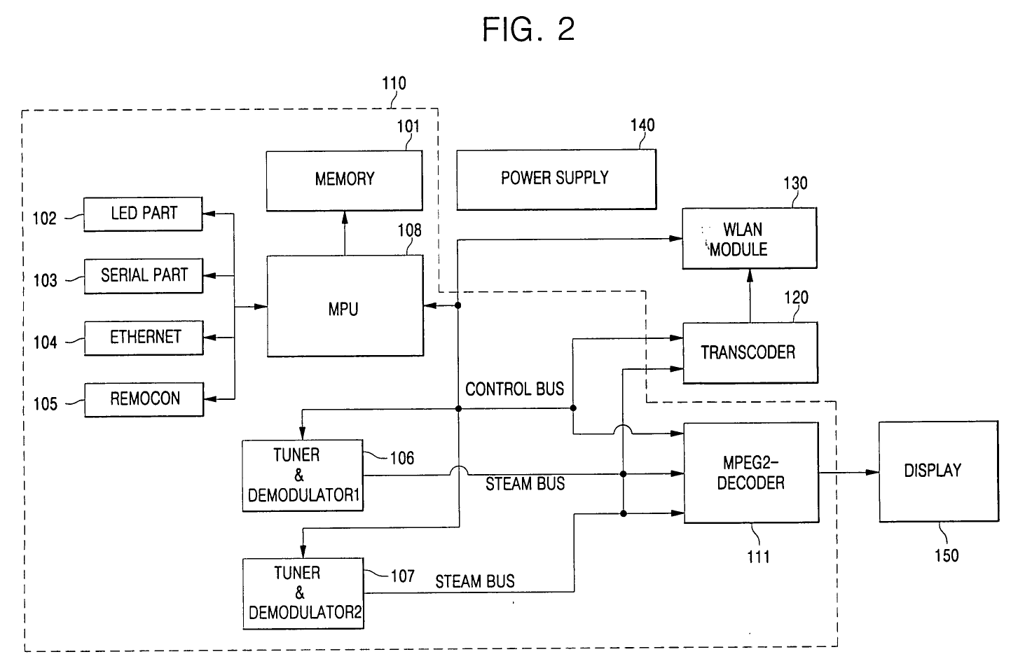

FIG. 2 is a block diagram of a multi-channel broadcasting receiver according to an embodiment of the present invention. That is, FIG. 2 is a block diagram of the STB 100 of FIG. 1.

Referring to FIG. 2, the STB 100 includes a DTV module 110, a transcoder 120, a WLAN module 130, a power supply 140 and a display 150. The operations of the DTV module 110, the transcoder 120, and the WLAN module 130 are as noted above with reference to FIG. 1.

To process the digital broadcasting data as described above, the DTV module 110 includes a memory 101, an interface 102, e.g., a Light Emitting Diode (LED), a serial part 103, an Ethernet module 104, a remote control module 105, a Main Processor Unit (hereinafter, referred to as an MPU) 108, a plurality of tuners and demodulators 106 and 107 (e.g., a first tuner and demodulator 106 and a second tuner and demodulator 107), and a Moving Picture Experts Group 2-decoder (MPEG 2-decoder) 111.

The memory 101 is a system memory and stores programs such as an operating system and applications.

The LED part 112 externally outputs operational states of the STB 100. The serial part 103 is for inputting information for setting operational states or environments of the STB 100. The Ethernet module 104 includes, as Ethernet ports, a port to interface with external networks, a port to interface with other internal devices (e.g., a personal computer), and the like. The remote control module 105 receives signals from the remote control via the port and sends the signals to the MPU.

The MPU 108 controls the overall operation of the STB 100 in accordance with program information stored in the memory 101. For example, the MPU 108 controls the reprocessing of the EPG data received from a digital broadcasting service provider into a format displayable on a wireless terminal device (e.g., PDA) having a small display area in accordance with a pre-stored EPG reprocessing program. The MPU also controls the operation of the transcoder 120 in accordance with a pre-stored bandwidth adjustment program to adjust the bandwidth of the digital broadcasting data so that the digital broadcasting data can be transmitted over the WLAN.

Each of the plurality of tuners and demodulators (e.g., the first tuner and demodulator 106 and the second tuner and demodulator 107) receives, demodulates and outputs the digital broadcasting data into MPEG2-TS (Transport Stream) format. In the present invention, the STB 100, as shown in FIG. 2, includes a plurality of tuners and demodulators 106 and 107 to receive and process various digital broadcasting data over one or more channels. Although in the example of FIG. 2 two tuner and demodulators have been illustrated, the present invention is not limited to having the two tuners and demodulators. The number of the tuners and demodulators can be determined based on a transmission bandwidth of the WLAN and a compressed state of the digital broadcasting data. For example, if the digital broadcasting data is compressed in bandwidth from 19.4 Mbps to 3 Mbps, it is possible to simultaneously transmit three channels over a WLAN having a transmission bandwidth of 11 Mbps. In this case, the STB 100 preferably includes three tuners and demodulators.

The MPEG 2-decoder 111 decodes the digital broadcasting data in the MPEG2-TS format received from the plurality of tuners and demodulators 106 and 107.

The display 150 receives the decoded signal from the MPEG 2-decoder 111 and displays the signal on the external display device (e.g., TV) connected to the STB 100.

The power supply 140 supplies necessary power to the STB 100. For example, the power supply 140 supplies the power to all components constituting the STB 100.

The transcoder 120 compresses the digital broadcasting data to reduce the bandwidth thereof under the control of the MPU 108. For example, the transcoder 120 converts digital broadcasting data in the MPEG2-TS format from the plurality of tuners and demodulators 106 and 107 to digital broadcasting data in an MPEG 4 format to reduce the bandwidth of the digital broadcasting data. The transcoder 120 can be composed of a plurality of transcoders to accommodate several PDAs. That is, the STB 100 can include two or more transcoders to transmit the digital broadcasting data to a number of PDAs.

The WLAN module 130 transmits signals from the transcoder 120 or the MPU 108 to the PDA via the WLAN or receives signals from the PDA via the WLAN. For example, the WLAN module 130 transmits the digital broadcasting data in the MPEG4 format from the transcoder 120 and the EPG data from the MPU 108 via the WLAN. The EPG data conveyed from the MPU 108 is not in a format when the EPG data is received from a digital broadcasting provider but in a recomposed format for delivery via the WLAN. The WLAN module 130 places the MPEG4 stream on an Internet Protocol (IP) layer and transmits it using a Real-time Transport Protocol (RTP).

The operation of the STB 100 of the present invention as configured is as follows.

First, the plurality of tuners and demodulators 106 and 107 receive and demodulate digital broadcasting data broadcasted by a digital broadcasting provider. For example, the tuner and demodulators 106 and 107 demodulate the digital broadcasting data at an Radio Frequency (RF) to 8VSB (Vestigial-SideBand) (e.g., ATSC) to produce an MPEG2-signal.

The MPEG2-signal is input from the plurality of tuners and demodulators 106 and 107 to the MPEG2-decoder 111 or the transcoder 120. A different delivery path for the MPEG2-signal is determined depending on the device on which the digital broadcasting signal is to be displayed.

For example, if the digital broadcasting signal is to be displayed on the TV, a digital broadcasting request signal is transmitted via the remote control module 105 and the MPEG2-signal is transmitted from the plurality of tuners and demodulators 106 and 107 to the MPEG2-decoder 111. On the other hand, if the digital broadcasting signal is to be displayed on the PDA, the digital broadcasting request signal is input via the WLAN module 130 and the MPEG2-signal is transmitted from the plurality of tuners and demodulators 106 and 107 to the transcoder 120.

The MPEG2-signal input to the MPEG2-decoder 111 is decoded into a format that can be output on the TV. When receiving the digital broadcasting request signal via the remote control module 105, the MPEG2-decoder 111 decodes the digital broadcasting data in the MPEG2 format received from the tuners and demodulators 106 and 107 and then transmits the decoded data to the display 150 so that the data is displayed on the TV. Basically, the MPEG2-decoder 111 parses an incoming broadcasting stream to separate the broadcasting stream into video, audio, and system data in conformity to an Advanced Television System Committee (ATSC) system. The MPEG2-decoder 111 decodes the video data into the MPEG2 format and audio data into audio coding-3 (AC-3).

On the other hand, the MPEG2-signal input to the transcoder 120 is converted into a format that can be outputted on the PDA. The transcoder 120 converts the input video stream in the MPEG2 to the MPEG4 (or H.264) format and the input audio stream in the AC-3 format to the MPEG4 format, and then conveys them to the WLAN module 130. This conversion reduces the digital broadcasting data from 19.4 Mbps to several Mbps, which becomes a format transmittable over the WLAN.

The WLAN module 130 then transmits the digital broadcasting data from the transcoder 120 to the PDA over the wireless LAN.

When the PDA requests additional information (e.g., EPG data) in addition to the digital broadcasting data, the MPU 108 of the STB 100 reads out EPG information from a pre-stored Service Information (SI) table in the MPEG2-decoder 111, recomposes the EPG information into a new format in conformity to the PDA, and transmits it to the WLAN module 130. For example, the MPU 108 extracts and recomposes only necessary EPG information from various EPG information in conformity with a feature of the PDA having a small display area, and transmits the recomposed EPG data to the WLAN module 130.

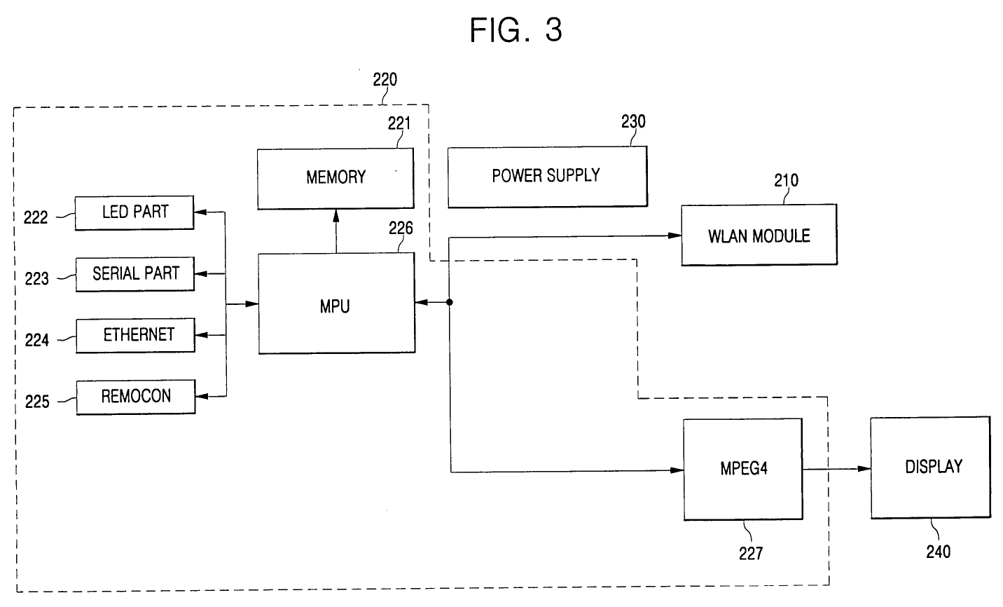

FIG. 3 is a block diagram of a Personal Digital Assistant (PDA) according to an embodiment of the present invention. That is, FIG. 3 is a block diagram of a PDA 200 of FIG. 1.

Referring to FIG. 3, the PDA 200 does not include a tuner and demodulator for receiving and demodulating digital broadcasting data and a module for parsing SI contained in the broadcasting stream in the MPEG2-TS format, but includes only an MPEG-4 decoder 227, a display 240, and interface modules 222 to 225.

The PDA 200 includes a WLAN module 210, a DTV module 220, a power supply 230, and a display 240. The operation of the WLAN module 210 and DTV module 220 is as described above with reference to FIG. 1.

The WLAN module 210 is connected to the WLAN module 130 of the STB 100 via the WLAN for transmitting control data (e.g., service request instructions) to the WLAN module 130 of the STB 100 (see FIGS. 1 and 2) and for receiving digital broadcasting data (e.g., A/V data) from the WLAN module 130 of the STB 100 and sending the received digital broadcasting data to the DTV module 220.

The DTV module 220 displays the digital broadcasting data received via the WLAN module 210. The DTV module 220 includes a memory 221, an interface (e.g., Light Emitting Diode (LED) part 222, a serial part 223, an Ethernet module 224, a remote control module 225, and the like), a main processor unit (hereinafter, referred to as ‘MPU’) 226, and an MPEG4 decoder 227.

The memory 221 is a system memory and stores programs such as an operating system and applications for managing the operation of the PDA 200.

The LED part 222 externally outputs an operational state of the PDA 200. The serial part 223 inputs information to set operational states or environments of the PDA 200. The Ethernet module 224 includes, as Ethernet ports, a port to interface with external networks, a port to interface with other internal devices (e.g., personal computer), and the like. The remote control module 225 receives a signal from the remote control via the port and sends the signal to the CPU.

The MPU 226 controls the overall operation of the PDA 200 based on the program information stored in the memory 221. For example, the MPU 226 controls the overall operation of the PDA 200 to output the digital broadcasting data received via the WLAN module 210 to the display 240.

The MPEG4 decoder 227 decodes the digital broadcasting data in the MPEG 4 format, which has been received from the STB 100 via the WLAN module 210.

The display 240 receives the decoded signal from the MPEG4 decoder 227 and displayd the signal on the display device (e.g., LCD) connected to the PDA 200.

The power supply 230 supplies necessary power to the PDA 200. For example, the power supply 230 supplies the power to all of the components constituting the PDA 200.

The operation of the PDA 200 of the present invention is as follows.

First, when receiving the EPG data or the digital broadcasting data in the MPEG4 format via the WLAN module 210, the MPU 226 transmits the data to the MPEG 4 decoder 227, and the MPEG 4 decoder 227 decodes the data (e.g., digital broadcasting data and EPG data) and transmits the decoded data to the display 240.

In particular, when the data received via the WLAN module 210 is MPEG4 digital broadcasting data, the MPU 226 removes a header from the digital broadcasting data in the MPEG4 format and transmits the data to the MPEG 4 decoder 227. Then, the MPEG 4 decoder 227 decodes the digital broadcasting data in the MPEG4 format and transmits the decoded broadcasting data to the display 240.

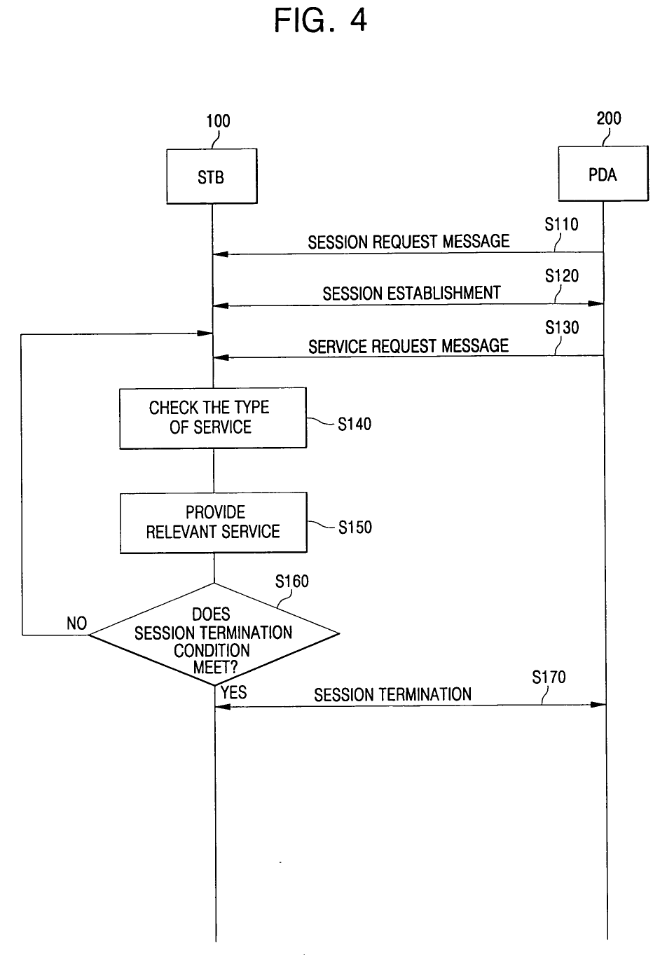

FIG. 4 is a process sequence diagram of a process of providing digital broadcasting data according to an embodiment of the present invention. In particular, FIG. 4 illustrates a process of providing digital broadcasting data using the apparatus for providing digital broadcasting data according to the present invention as shown in FIGS. 1 to 3. The process of providing the digital broadcasting data according to an embodiment of the present invention is discussed below with reference to FIG. 4.

First, if the PDA 200 sends a session request message to the STB 100 via the WLAN S110 to receive the digital broadcasting data from the STB 100 and a session is established between the STB 100 and the PDA 200 (S120). The session request and the corresponding session establishment process (S110 and S120) preferably utilizes processing that is typically used for data exchange between arbitrary devices in the WLAN.

However, the STB 100 and the PDA 200 each include a WLAN processing module.

After the session establishment between the STB 100 and the PDA 200 in S120 has been completed, if the PDA 200 sends a service request message to the STB 100 (S130), then the STB 100 analyzes the service request message to confirm the type of service (S140) and then provides a relevant service (e.g., a digital broadcasting service, a STB state information providing service, an EPG data providing service, or the like) (S150).

The STB 100 determines if a termination condition for the session established in S120 has been met (S160). If the session termination condition has been met (e.g., if the PDA 200 forwards a request for a termination of the established session to the STB 100), then the STB 100 terminates the session established between the STB 100 and the PDA 200 (S170).

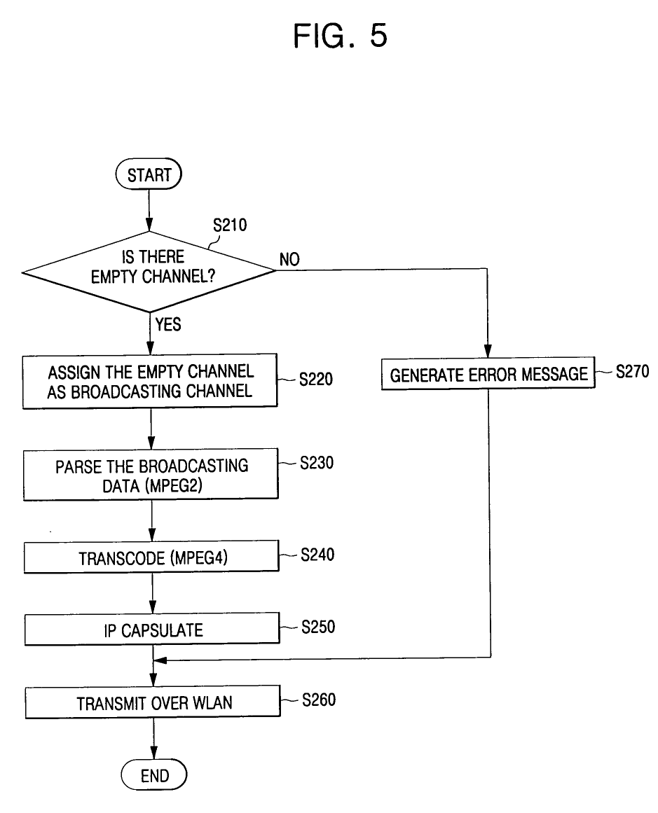

FIGS. 5 to 8 illustrate processing at the STB 100 in accordance with the type of service that the PDA 200 requests to the STB 100 in S130 of FIG. 4.

FIG. 5 is a flowchart of a process in which a multi-channel broadcasting receiver according to an embodiment of the present invention provides a corresponding service in response to a PDA's broadcasting data request. That is, FIG. 5 illustrates processing at the responding STB 100 when the PDA 200 requests a digital broadcasting service in S130 of FIG. 4.

Referring to FIG. 5, when receiving a digital broadcasting service request message from the PDA 200, the STB 100 checks whether there is an empty channel of the data transmission channels that are allowed for the STB 100 (S210). That is, the STB 100 checks whether there is a remaining bandwidth of a transmission bandwidth of the WLAN connected between the STB 100 and the PDA 200 and whether there is a tuner and a decoder that are currently not being used. For example, when the interconnection between the STB 100 and the PDA 200 is over the 802.11b network, the STB 100 checks whether there is a remaining bandwidth out of a transmission bandwidth of 11 Mbps assigned to the 802.11b network.

If it has been determined in S210 that there is an empty channel, the STB 100 assigns the channel as a broadcasting channel (S220). The STB 100 receives the digital broadcasting data requested by the PDA 200 and then parses the digital broadcasting data into digital broadcasting data in the MPEG2 format (S230). The STB 100 decodes (i.e., transcodes) the parsed digital broadcasting data in the MPEG2 format into digital broadcasting data in the MPEG4 format (S240), IP capsulates the digital broadcasting data (S250), and transmits the digital broadcasting data via the WLAN (S260).

On the other hand, if it has been determined in S210 that there is no empty channel, the STB 100 produces and sends an error message (S270) to the PDA 200.

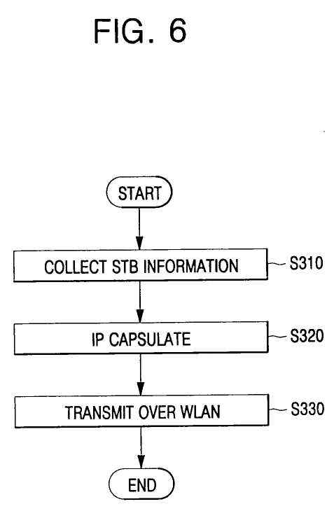

FIG. 6 is a flowchart of a process in which a multi-channel broadcasting receiver according to an embodiment of the present invention provides a corresponding service in response to a PDA's state information request. That is, FIG. 6 illustrates processing at the responding STB 100 when the PDA 200 requests state information of the STB 100 in the process (S130) of FIG. 4.

Referring to FIG. 6, when receiving a message requesting state information of the STB 100 from the PDA 200, the STB 100 collects information (e.g., operational state) of the STB 100 (S310), IP capsulates the information (S320), and then transmits the IP capsulated information to the PDA 200 via the WLAN (S330).

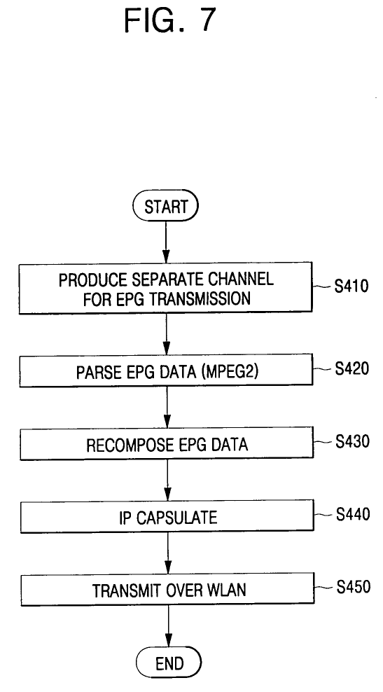

FIG. 7 is a flowchart of a process in which a multi-channel broadcasting receiver according to an embodiment of the present invention provides a corresponding service in response to a PDA's EPG request. That is, FIG. 7 illustrates processing at the responding STB 100 when the PDA 200 requests EPG data in S130 of FIG. 4.

Referring to FIG. 7, when receiving an EPG data request message from the PDA 200, the STB 100 produces a separate channel for EPG data transmission between the STB 100 and the PDA 200 (S410). The separate channel refers to a channel different from the channel for broadcasting data transmission. That is, the EPG data is transmitted via another port.

Furthermore, the STB 100 parses the EPG data to convert the EPG data into an MPEG2 format (S420), and then recomposes the converted EPG data into a format displayable on the PDA 200 (S430). The STB 100 also IP capsulates the recomposed EPG data (S440) to transmit the EPG data to the PDA 200 via the WLAN (S450).

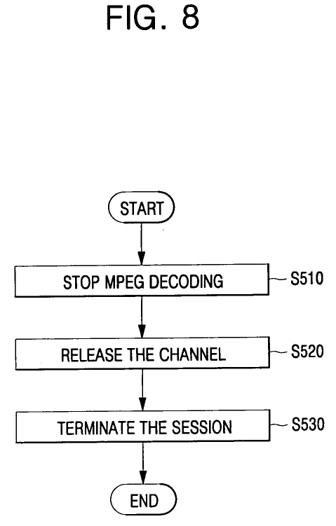

FIG. 8 is a flowchart of a process in which a multi-channel broadcasting receiver according to an embodiment of the present invention provides a corresponding service in response to a PDA's session termination request. That is, FIG. 8 illustrates processing at the responding STB 100 when the PDA 200 requests the termination of the session in S170 of FIG. 4.

Referring to FIG. 8, when receiving a session termination request message from the PDA 200, the STB 100 stops decoding the digital broadcasting data in MPEG4 format (S510), releases the channel established for transmitting the data (S520), and then terminates the session established between the STB 100 and the PDA 200 (S530).

Although the exemplary embodiments of the apparatus and method for providing the digital broadcasting data, received at the STB, through the PDA have been described, it will be apparent that various changes can be made to the present invention without departing from the spirit and scope of the present invention. For example, although the apparatus and method for providing the digital broadcasting data, received at the STB, through the PDA has been described by way of example, the device that receives the digital broadcasting data from the STB is not limited to the PDA. That is, the device receiving the digital broadcasting data from the STB includes all wireless terminal devices that can be connected to the STB via the WLAN and can process video and audio data. Therefore, the present invention is not limited to the illustrated embodiments but rather is defined by the claims below.

As described above, it is possible to transmit the received digital broadcasting data via the WLAN as the STB converts the bandwidth of the received digital broadcasting data and outputs the converted digital broadcasting data. Thus, it is possible for users to more conveniently view the digital broadcasting using the wireless terminal, the wireless terminal receiving the digital broadcasting data from an STB and outputting it to the users.

What is claimed is:

1. An apparatus comprising:
a digital broadcasting processor adapted to receive, demodulate, decode, and output multi-channel digital broadcasting data;
a transcoder adapted to receive the demodulated digital broadcasting data from the digital broadcasting processor, to convert the digital broadcasting data into a format transmittable over a Wireless Local Area Network (WLAN), and to output the converted digital broadcasting data; and
a WLAN processor adapted to transmit the converted digital broadcasting data to a wireless terminal device connected to the WLAN.

2. The apparatus according to claim 1, wherein the transcoder is adapted to compress the demodulated digital broadcasting data to reduce its bandwidth.

3. The apparatus according to claim 2, wherein the transcoder is adapted to compress the demodulated digital broadcasting data to reduce its bandwidth to be less than a transmission bandwidth of the WLAN connected to the wireless terminal device.

4. The apparatus according to claim 1, wherein the digital broadcasting processor comprises at least one tuner and demodulator adapted to receive the multi-channel digital broadcasting data.

5. The apparatus according to claim 4, wherein the transcoder is adapted to compress a bandwidth of the demodulated digital broadcasting data, wherein a transmission bandwidth of the WLAN connected to the wireless terminal device being compressed to be less than a value divided by the number of receivable channels in the digital broadcasting processor.

6. The apparatus according to claim 1, wherein, in response to a program information request from the wireless terminal device, the digital broadcasting processor is adapted to recompose pre-stored program information into a format displayable on the wireless terminal device and to transmit the recomposed program information to the WLAN processor.

7. The apparatus according to claim 1, wherein the wireless terminal device comprises a Personal Digital Assistant (PDA).

8. A wireless terminal device comprising:
a Wireless Local Area Network (WLAN) processor adapted to, in response to a user's request, connect to a multi-channel broadcasting receiver that receives multi-channel digital broadcasting data via a WLAN, request the digital broadcasting data from the multi-channel broadcasting receiver, and receive the digital broadcasting data from the multi-channel broadcasting receiver; and
a digital broadcasting processor adapted to demodulate, decode and output the digital broadcasting data received by the WLAN processor.

9. The device according to claim 8, comprising a Personal Digital Assistant (PDA).

10. A method comprising:
establishing a session using a Wireless Local Area Network (WLAN) between a multi-channel broadcasting receiver and a wireless terminal device, the wireless terminal device being connected to the multi-channel broadcasting receiver via the WLAN, in response to a wireless terminal device's request;
converting digital broadcasting data received by the multi-channel broadcasting receiver into a format transmittable via the WLAN in response to a digital broadcasting service request from the wireless terminal device; and
transmitting the converted digital broadcasting data to the wireless terminal device via the WLAN.

11. The method according to claim 10, wherein converting the digital broadcasting data comprises compressing the digital broadcasting data received by the multi-channel broadcasting receiver to reduce its bandwidth.

12. The method according to claim 11, wherein converting the digital broadcasting data comprises compressing a bandwidth of the digital broadcasting data received by the multi-channel broadcasting receiver to be less than a transmission bandwidth of the WLAN.

13. The method according to claim 11, wherein converting the digital broadcasting data comprises compressing a bandwidth of the digital broadcasting data received byhe multi-channel broadcasting receiver, a transmission bandwidth of the WLAN being compressed to be less than a value divided by the number of receivable channels in the digital broadcasting processor.

14. The method according to claim 10, further comprising:
recomposing, by the multi-channel broadcasting receiver, pre-stored program information into a format displayable on the wireless terminal device in response to a program information request from the wireless terminal device; and
transmitting the recomposed program information to the wireless terminal device via the WLAN.

15. The method according to claim 14, further comprising establishing a separate channel to transmit the recomposed program information.
